(19) United States
(12) Patent Application Publication
(10) Pub. No.: US 2022/0111299 A1
(43) Pub. Date: Apr. 14, 2022

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Takashi Totsuka, Tokyo (JP); Taiki Ishikawa, Tokyo (JP); Hiroyuki Nishimura, Tokyo (JP)

(73) Assignee: CYGAMES, INC., Tokyo (JP)

(21) Appl. No.: 17/557,658

(22) Filed: Dec. 21, 2021

Related U.S. Application Data
(63) Continuation of application No. PCT/JP2020/024843, filed on Jun. 24, 2020.

(30) Foreign Application Priority Data
Jun. 24, 2019 (JP) 2019-116315

(51) Int. Cl. A63F 13/87; A63F 13/792; A63F 13/69

(52) U.S. Cl. CPC A63F 13/87; A63F 13/69; A63F 13/792

(57) ABSTRACT

A non-transitory computer readable medium stores a program causing a computer to execute: sending a comment input by a user when transmission of the comment is ordered and the comment satisfies a predetermined transmission condition; displaying the sent comment in a list; specifying an amount of value to be donated to a donation target; and sending the comment and the specified amount of value when transmission of the comment and the specified amount of value is ordered and the comment satisfies the transmission condition, wherein displaying the sent comment in the list includes displaying the comment and the specified amount of value with being associated with each other when the comment and the specified amount of value are sent, and wherein the value can be donated only when the comment is sent.

### CROSS REFERENCE TO RELATED APPLICATIONS

This application is a continuation application of International Application No. PCT/JP2020/024843, filed on Jun. 24, 2020, which claims priority to Japanese Patent Application No. 2019-116315, filed on Jun. 24, 2019, the entire contents of which are incorporated by reference herein.

### BACKGROUND ART

### Technical Field

The present invention relates to an information processing program, an information processing method, and an information processing system.

As shown in Patent Literature 1, for example, information processing systems in which “like” points are assigned to a user who has uploaded content, by consuming purchased coins (value information), have hitherto been known.

### Citation List

### Patent Literature

Patent Literature 1: JP 6401133 B

### SUMMARY OF INVENTION

### Technical Problem

Information processing systems that have a comment display function for sending comments with respect to each content item and for displaying the sent comments in a list have also been proposed. In such information processing systems, only the comments are simply displayed, and there is a demand for adding elements that can further liven-up the comment display function.

An object of the present invention is to provide an information processing program, an information processing method, and a game device that make it possible to liven-up a comment display function.

### Solution to Problem

In order to solve the problem described above, the present invention provides an information processing program causing a computer to function as: a comment transmitting unit that sends a comment input by a user if the comment satisfies a predetermined transmission condition, in the case where a comment transmission operation section is operated; a comment displaying unit that displays the sent comment in a list; a value-information specifying unit that specifies a specified amount of value information to be donated to a donation target; and a value-information-attached-comment transmitting unit that sends the comment and information about the specified amount of the value information if the comment satisfies the transmission condition, in the case where a value-information-attached-comment transmission operation section is operated, wherein the comment displaying unit displays the comment and the specified amount of the value information in linkage with each other, in the case where the comment is sent by operating the value-information-attached-comment transmission operation section, and wherein the value information can be donated only when the comment is sent.

The value-information-attached-comment transmission operation section may be able to be operated in the case where a partial condition, of the transmission condition, that the comment having at least one letter is input to a comment input region is satisfied.

The value-information-attached-comment transmitting unit may send only the comment when the value-information-attached-comment transmission operation section is operated in the case where the specified amount of the value information specified by means of the value-information specifying unit is 0.

The value information may include free value information that can be obtained for free and pay value information that can be obtained for a fee, and the free value information and the pay value information may be managed separately; the value-information specifying unit may be able to specify a specified amount of the value information without distinguishing between the free value information and the pay value information; and, in the case where the comment and information about the specified amount of the value information are sent by operating the value-information-attached-comment transmission operation section, the free value information may be consumed first.

In order to solve the problem described above, the present invention provides an information processing method including: sending a comment input by a user if the comment satisfies a predetermined transmission condition, in the case where a comment transmission operation section is operated; displaying the sent comment in a list; specifying a specified amount of value information to be donated to a donation target; sending the comment and information about the specified amount of the value information if the comment satisfies the transmission condition, in the case where a value-information-attached-comment transmission operation section is operated; and displaying the comment and the specified amount of the value information in linkage with each other, in the case where the comment is sent by operating the value-information-attached-comment transmission operation section, wherein the value information can be donated only when the comment is sent.

In order to solve the problem described above, the present invention provides an information processing system including: a comment transmitting unit that sends a comment input by a user if the comment satisfies a predetermined transmission condition, in the case where a comment transmission operation section is operated; a comment displaying unit that displays the sent comment in a list; a value-information specifying unit that specifies a specified amount of value information to be donated to a donation target; and a value-information-attached-comment transmitting unit that sends the comment and information about the specified amount of the value information if the comment satisfies the transmission condition, in the case where a value-information-attached-comment transmission operation section is operated, wherein the comment displaying unit displays the comment and the specified amount of the value information in linkage with each other, in the case where the comment is sent by operating the value-information-attached-comment transmission operation section, and wherein the value information can be donated only when the comment is sent.

### Effects of Disclosure

According to the present invention, it is possible to liven-up a comment display function.

### BRIEF DESCRIPTION OF DRAWINGS

FIG. 1 is an explanatory view showing, in outline, the configuration of an information processing system.

FIG. 2A is a diagram for explaining the hardware configuration of a player terminal.

FIG. 2B is a diagram for explaining the hardware configuration of a server.

FIG. 3A is a view showing an example of a home screen.

FIG. 3B is a view for explaining an example of a serial screen.

FIG. 3C is a view showing an example of a read-all-at-once screen.

FIG. 3D is a view for explaining an example of a bookshelf screen.

FIG. 4A is a first view showing an example of a chapter selection screen.

FIG. 4B is a second view showing the example of the chapter selection screen.

FIG. 4C is a view showing an example of a comic screen.

FIG. 4D is a second view showing an example of an end screen.

FIG. 5A is a first view for explaining an example of a comment-list screen.

FIG. 5B is a second view for explaining the example of the comment-list screen.

FIG. 5C is a third view for explaining the example of the comment-list screen.

FIG. 5D is a fourth view for explaining the example of the comment-list screen.

FIG. 6A is a first view for explaining an example of a specified-amount selection pop-up.

FIG. 6B is a second view for explaining the example of the specified-amount selection pop-up.

FIG. 6C is a view for explaining an example of a coin-attached-post end pop-up.

FIG. 6D is a view for explaining an example of the comment-list screen displayed after a coin-attached post is finished.

FIG. 7A is a view for explaining viewing-state classifications, determination conditions, start conditions, and end conditions.

FIG. 7B is a view for explaining an example case where a comic icon is displayed in a recommended-comic display region in accordance with the viewing state thereof.

FIG. 8 is a sequence diagram for explaining the basic processing at a user terminal and the server.

FIG. 9 is a view for explaining the configuration of a memory and the function as a computer at the user terminal.

FIG. 10 is a flowchart for explaining an example of terminal-side processing at the user terminal.

FIG. 11 is a flowchart for explaining an example of recommendation displaying processing at the user terminal.

FIG. 12 is a flowchart for explaining an example of comment displaying/transmitting processing at the user terminal.

FIG. 13 is a view for explaining the configuration of a memory and the function as a computer at the server.

FIG. 14 is a flowchart for explaining an example of server-side processing at the server.

FIG. 15 is a flowchart for explaining an example of comment handling processing at the server.

FIG. 16 is a flowchart for explaining an example of recommendation determining processing at the server.

### DESCRIPTION OF EMBODIMENT

An aspect of an embodiment of the present invention will be described below in detail with reference to the accompanying drawings. The dimensions, materials, other specific values, etc. given in this embodiment are merely examples for facilitating understanding, and do not limit the present invention unless otherwise specifically mentioned. Note that, in this description and the drawings, duplication of description will be omitted by assigning identical reference signs to elements that have substantially the same functions and configurations, and elements that are not directly related to the present invention are not shown.

(Overall Configuration of Information Processing System S)

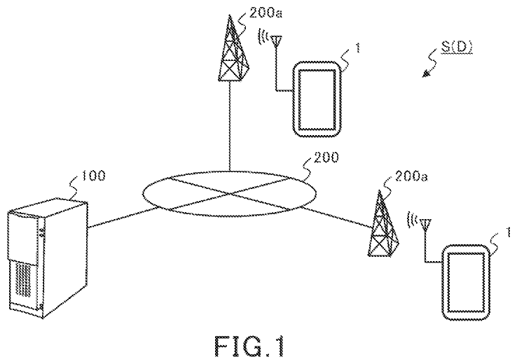

FIG. 1 is an explanatory view showing, in outline, the configuration of an information processing system S. The information processing system S is a so-called client/server system that includes user terminals 1, a server 100, and a communication network 200 having communication base stations 200a.

Each of the user terminals 1 can establish communication with the server 100 via the communication network 200. The user terminals 1 widely include electronic appliances that can be communicatively connected to the server 100 by wire or wirelessly. Examples of the user terminals 1 include smartphones, mobile phones, tablet devices, personal computers, or the like. In this embodiment, a description will be given of a case in which smartphones are used as the user terminals 1.

The server 100 is communicatively connected to a plurality of user terminals 1. The server 100 accumulates various kinds of information (user information) for each user ID used to identify a user who views content. Furthermore, the server 100 provides the user terminals 1 with content.

The communication base stations 200a are connected to the communication network 200 to send and receive information to and from the user terminals 1 wirelessly. The communication network 200 is configured of a mobile-phone network, the Internet, a local area network (LAN), a dedicated line, or the like, to realize wireless or wired communication connection between the user terminals 1 and the server 100.

In the information processing system S according to this embodiment, the user terminals 1 and the server 100 function as information processing devices D. The user terminals 1 and the server 100 respectively play roles for controlling the viewing of content, whereby it is possible to view content in cooperation of the user terminals 1 and the server 100.

(Hardware Configuration of User Terminal 1 and Server 100)

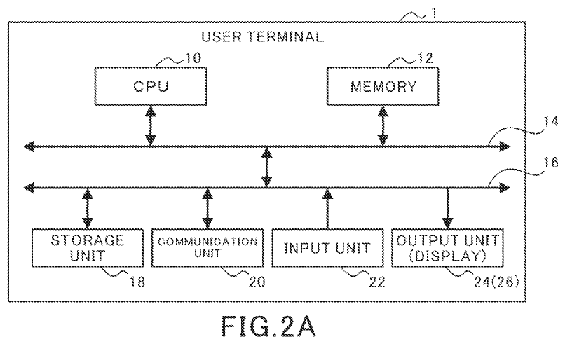

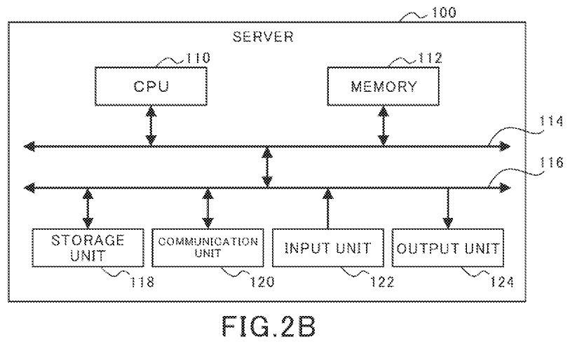

FIG. 2A is a diagram for explaining the hardware configuration of the user terminal 1. Furthermore, FIG. 2B is a diagram for explaining the hardware configuration of the server 100. As shown in FIG. 2A, the user terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 100 is configured to include a CPU 110, a memory 112, a bus 114, an input/output interface 116, a storage unit 118, a communication unit 120, an input unit 122, and an output unit 124.

Note that the configurations and the functions of the CPU 110, the memory 112, the bus 114, the input/output interface 116, the storage unit 118, the communication unit 120, the input unit 122, and the output unit 124 of the server 100 are substantially the same as the CPU 10, the memory 12, the bus 14, the input/output interface 16, the storage unit 18, the communication unit 20, the input unit 22, and the output unit 24 of the user terminal 1, respectively. Therefore, the hardware configuration of the user terminal 1 will be described below, and a description of the server 100 will be omitted.

The CPU 10 runs a program stored in the memory 12 to control the viewing of content. The memory 12 is configured of a read only memory (ROM) or a random access memory (RAM) and stores programs and various kinds of data needed for controlling the viewing of content. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory such as a dynamic random access memory (DRAM) and stores programs and data. In the user terminal 1, programs and data stored in the storage unit 18 are loaded into the memory 12 (RAM) by the CPU 10.

The communication unit 20 is communicatively connected to the communication base station 200a wirelessly, and sends information to and receives information from the server 100 via the communication network 200, such as various kinds of data and programs. In the user terminal 1, the programs etc. received from the server 100 are stored in the memory 12 or the storage unit 18.

The input unit 22 is configured of, for example, a touchscreen, buttons, a keyboard, a mouse, a cross key, or an analog controller with which player operations are input (operations are accepted). Alternatively, the input unit 22 may also be a dedicated controller provided in the user terminal 1 or connected (externally attached) to the user terminal 1. Alternatively, the input unit 22 may be configured of an acceleration sensor that detects tilting or movement of the user terminal 1 or a microphone that detects speech of the player. That is, the input unit 22 may widely include devices that enable the player to input his or her intents in distinguishable manners.

The output unit 24 is configured to include a display device and a speaker. Note that the output unit 24 may be a device connected (externally attached) to the user terminal 1. In this embodiment, the user terminal 1 includes a display 26 as the output unit 24, and includes, as the input unit 22, a touchscreen provided in the display 26 in such a manner as to be overlaid thereon.

(Viewing of Content)

Next, an example of control of viewing of content executed by the information processing system S (information processing device D) of this embodiment will be described below. In this embodiment, a plurality of content items are provided, each content item being composed of a plurality of partial content items. Here, a description will be given of an example case in which the content is a comic. The comic is composed of chapters (episodes) serving as partial content items. Note that the content is not limited to a comic and may be a moving image, a single still image, or music, and may be any type of content as long as the content is composed of a plurality of partial content items. Furthermore, preferably, the partial content items have continuity.

In the user terminal 1, an application dedicated to viewing comics is provided by the server 100. In the user terminal 1, after the application dedicated to viewing comics is downloaded, the application is executed, whereby viewing of comics is allowed. The server 100 assigns user IDs to the individual user terminals 1 into which the application dedicated to viewing comics has been downloaded, and stores, for each of the user IDs, user information including at least comic viewing history and value information. Furthermore, the server 100 adds and updates a chapter of a comic at every predetermined update timing. In this embodiment, the server 100 adds a new chapter once a week. Note that the update timing is not limited to once a week, but may be various update timings, such as once every two weeks or twice a week.

The viewing history at least includes, for each content item (comic), the date and time at which the content (comic) was viewed last and information about the viewed chapter.

The value information is used to view some of content and is provided in the form of coin in this embodiment. The value information (coins) is stored in the server 100 in such a form as to be distinguished between: free value information (free coins) provided for free; and pay value information (pay coins) provided for a fee. Note that just coins are referred to when a description is given without distinguishing between the free coins and the pay coins.

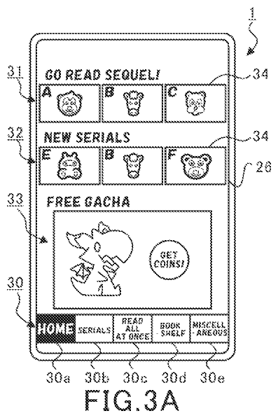

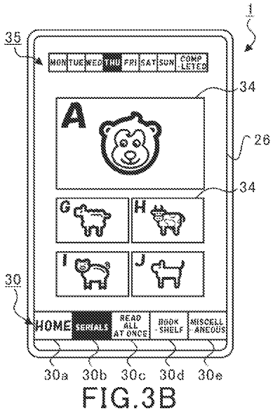

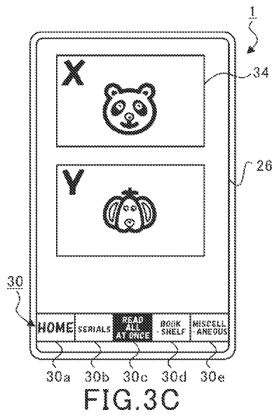

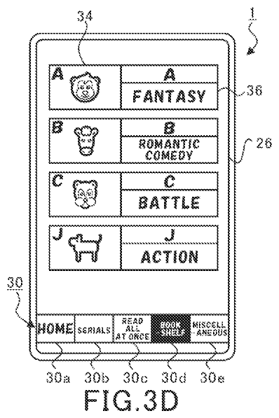

FIG. 3A is a view showing an example of a home screen. FIG. 3B is a view for explaining an example of a serial screen. FIG. 3C is a view showing an example of a read-all-at-once screen. FIG. 3D is a view for explaining an example of a bookshelf screen.

When the application dedicated to viewing comics is executed, the user terminal 1 displays the home screen shown in FIG. 3A, as an initial screen, on the display 26. A menu bar 30 is displayed at a lower section of the home screen. A plurality of operation sections that can be operated (tapped) by a player are provided on the menu bar 30. The menu bar 30 includes: a home-screen operation section 30a, in which “home” is written; a serial-screen operation section 30b, in which “serial” is written; a read-all-at-once-screen operation section 30c, in which “read all at once” is written; a bookshelf-screen operation section 30d, in which “bookshelf” is written; and an other-screen operation section 30e, in which “other” is written.

When the home-screen operation section 30a is tapped, the home screen shown in FIG. 3A is displayed on the display 26. Furthermore, when the serial-screen operation section 30b is tapped, the serial screen shown in FIG. 3B is displayed on the display 26. Similarly, when the read-all-at-once-screen operation section 30c is tapped, the read-all-at-once screen shown in FIG. 3C is displayed on the display 26. Furthermore, when the bookshelf-screen operation section 30d is tapped, the bookshelf screen shown in FIG. 3D is displayed on the display 26. Furthermore, when the other-screen operation section 30e is tapped, an other screen (not shown) is displayed on the display 26. Note that, although a detailed description of the other screen will be omitted, it is possible to display coins associated with the user ID on the other screen and to purchase pay coins thereon.

In order to be able to identify the screen currently displayed on the display 26, the operation section corresponding to the currently displayed screen is highlighted in the menu bar 30.

The home screen has, in order from the top, a recommended-comic display region 31, a new-serial display region 32, and a free-gacha display region 33. In the recommended-comic display region 31, one or a plurality of comic icons 34 are displayed together with a character string “let's read next!”. The comic icons 34 are set individually for comics. Each of the comic icons 34 is, for example, an image that indicates the corresponding comic and that makes it easy for the user to confirm an image of a main character or the title of the comic.

In the recommended-comic display region 31, the comic icon 34 of a comic that has been viewed at least once by the user is displayed when a predetermined display condition is satisfied, as will be described later in detail. Note that, in the recommended-comic display region 31, nine comic icons 34 can be displayed at most. Then, if ten or more comics satisfy the display condition, a predetermined icon is displayed in the recommended-comic display region 31, and, when the predetermined icon is operated, a screen for displaying all the comic icons 34 of those comics satisfying the display condition is displayed on the display 26.

In the new-serial display region 32, the comic icon 34 of a new serial comic is displayed. Note that the new serial comic is a comic that is newly added to the server 100 or a comic that has already been added to the server 100 and that has started to be newly provided. In the free-gacha display region 33, an image that can accept a user operation once a day, for example, is displayed, and, when an operation is performed by the user, a predetermined amount of free coins is assigned to the user.

When the serial-screen operation section 30b is tapped, the serial screen shown in FIG. 3B is displayed on the display 26. A day-of-week selection section 35 is displayed in an upper section of the serial screen. The day-of-week selection section 35 has: seven selection sections (“Monday” to “Sunday”) for displaying the comic icons 34 of comics that are to be updated on the corresponding days of the week from Monday to Sunday; and a selection section (“completed”) for displaying the comic icons 34 of comics that have been completed. In the day-of-week selection section 35, the selected operation section is highlighted so as to be able to identify the selected day of the week (or “completed”). In the serial screen, the comic icons 34 of comics that are to be updated on the day of the week selected in the day-of-week selection section 35 (or, of completed comics) are displayed below the day-of-week selection section 35. Note that the menu bar 30 is displayed in the serial screen.

When the read-all-at-once-screen operation section 30c is tapped, the read-all-at-once screen shown in FIG. 3C is displayed on the display 26. The comic icon 34 of completed comics are displayed in the read-all-at-once screen. Note that the menu bar 30 is displayed in the read-all-at-once screen.

When the bookshelf-screen operation section 30d is tapped, the bookshelf screen shown in FIG. 3D is displayed on the display 26. In the bookshelf screen, a list of the comic icons 34 of comics that have been viewed at least once by the user are displayed on the basis of the user's viewing history. Furthermore, a comic description field 36 in which the title of the comic and a summary of the comic are described is displayed at the right side of each of the comic icons 34. Note that the menu bar 30 is displayed in the bookshelf screen.

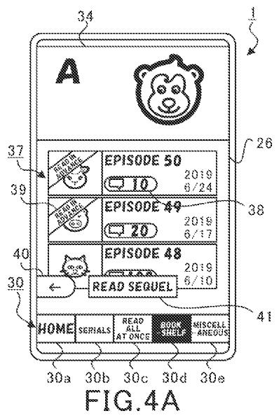

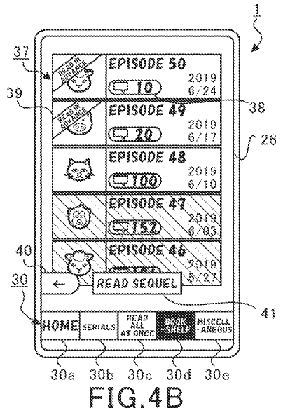

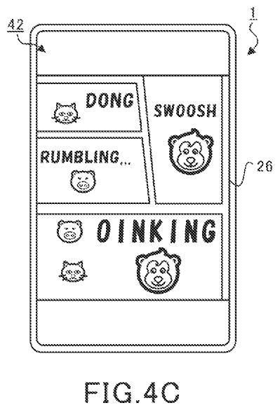

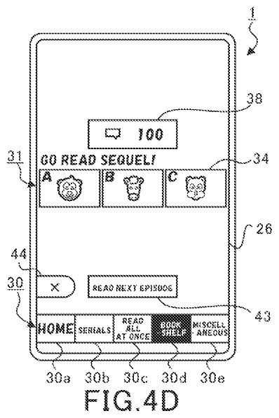

FIG. 4A is a first view showing an example of a chapter selection screen. FIG. 4B is a second view showing the example of the chapter selection screen. FIG. 4C is a view showing an example of a comic screen. FIG. 4D is a second view showing an example of an end screen.

When any of the comic icons 34 displayed on the home screen, the serial screen, the read-all-at-once screen, or the bookshelf screen is tapped, as shown in FIGS. 4A and 4B, a chapter selection screen for the comic indicated by the tapped comic icon 34 is displayed on the display 26. The comic icon 34 is displayed at an upper section of the chapter selection screen, and chapter selection images 37 for selecting individual chapters are displayed below the comic icon 34. The chapter selection images 37 are displayed in such an order that a newly updated (latest) chapter is displayed at the top and other chapters are displayed in descending order of update date. In each of the chapter selection images 37, an image of one representative frame for the chapter, a chapter number (for example, “50th episode”), and an update date are displayed, and a comment operation section 38 is included. Note that the comment operation section 38 will be described in detail later.

In the chapter selection screen, the chapter selection images 37 are displayed in a scrolling manner when the user performs a scroll operation. Furthermore, in the chapter selection screen, on the basis of the user's viewing history, the chapter selection images 37 of chapters that have been viewed by the user (the chapter selection images 37 of a 47th episode and a 46th episode shown in FIG. 4B) are displayed so as to be darker than the other chapter selection images 37. Accordingly, the chapters that have been viewed by the user can be easily identified.

Furthermore, for the chapter selection images 37 of the chapter of the latest episode and the chapter that is one-episode older than the latest episode (the chapter selection images 37 of a 50th episode and a 49th episode shown in FIG. 4A), read-in-advance ribbons 39, in each of which “read in advance” is written, are displayed in such a manner as to be overlaid thereon. In this embodiment, the chapter of the latest episode and the chapter that is one-episode older than the latest episode can be viewed by consuming coins. In this way, a chapter that can be viewed by consuming coins is referred to as a pay chapter (pay partial content), and a chapter that can be viewed without consuming coins is referred to as a free chapter (free partial content).

That is, the read-in-advance ribbon 39 indicates that the corresponding chapter can be viewed by consuming coins. For example, it is assumed that a comic titled “A” is updated on Thursdays (0:00 on Thursdays). In this case, a new chapter is added as a pay chapter at 0:00 on Thursdays. Furthermore, the chapter that is two-episodes older than the newly added chapter is changed from a pay chapter to a free chapter.

Furthermore, in the chapter selection screen, a return operation section 40 and a read-next operation section 41 are displayed above the menu bar 30. When the return operation section 40 is tapped, the home screen, the serial screen, the read-all-at-once screen, or the bookshelf screen that was displayed before the chapter selection screen is displayed is displayed on the display 26.

When any of the chapter selection images 37 displayed on the chapter selection screen is tapped, the comic screen of the chapter corresponding to the tapped chapter selection image 37 is displayed on the display 26, as shown in FIG. 4C. Note that, although a detailed description will be omitted, in the case where the chapter selection image 37 of a pay chapter is tapped, the amount of coins needed to view the pay chapter is displayed, and an operation section for selecting whether to view the pay chapter by consuming the amount of coins is displayed.

Here, when any of the chapter selection images 37 is tapped, the user terminal 1 sends, to the server 100, viewing request information for requesting to view the chapter corresponding to the tapped chapter selection image 37. At the server 100, the viewing history is updated on the basis of the received viewing request information, and URL information indicating URL of the chapter is sent to the user terminal 1. The user terminal 1 accesses the URL indicated in the received URL information, downloads images of the chapter, and displays the images in the comic screen.

Furthermore, when the read-next operation section 41 is tapped, the user terminal 1 sends, to the server 100, viewing request information for requesting to view the next chapter after the latest chapter viewed by the user. Accordingly, at the user terminal 1, images of the next chapter after the latest chapter viewed by the user are displayed in the comic screen.

Each chapter is composed of a plurality of page images 42 equivalent to a plurality of pages. In the comic screen, of the plurality of page images 42 composing the chapter, one page image 42 is displayed. Then, when the user performs a flick operation, the next page image 42 is displayed on the display 26.

Then, when the user performs a flick operation with the last page image 42 being displayed, the end screen shown in FIG. 4D is displayed on the display 26. In the end screen, the menu bar 30, the recommended-comic display region 31, and the comment operation section 38 are displayed, and a next-episode operation section 43 for selecting the next chapter and a screen-closing operation section 44 are displayed on the display 26.

When the next-episode operation section 43 is tapped, the user terminal 1 sends, to the server 100, viewing request information for requesting to view the next chapter after the chapter that was viewed. Accordingly, at the user terminal 1, the next chapter can be continuously viewed.

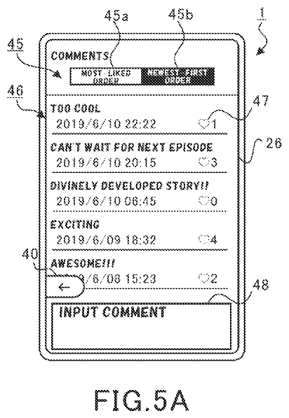

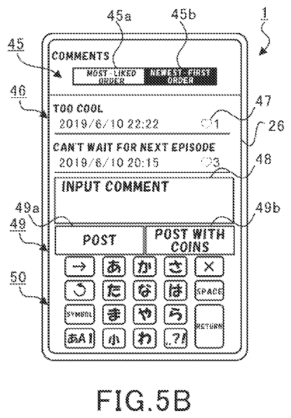

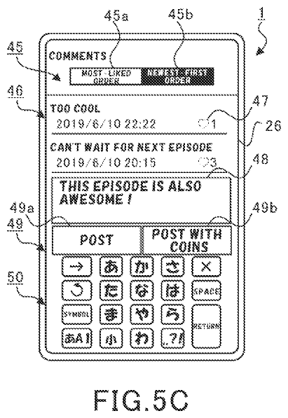

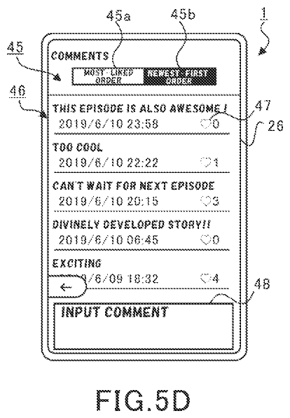

FIG. 5A is a first view for explaining an example of a comment-list screen. FIG. 5B is a second view for explaining the example of the comment-list screen. FIG. 5C is a third view for explaining the example of the comment-list screen. FIG. 5D is a fourth view for explaining the example of the comment-list screen.

The comment operation section 38, shown in FIGS. 4A, 4B, and 4D, is provided in each of the chapters. Furthermore, the number of comments is also displayed in the comment operation section 38. As the number of comments, the total number of comments posted by all users is displayed. Therefore, it is possible to grasp, to some extent, the popularity of the chapter or the comic by checking the number of comments.

When the comment operation section 38 is tapped, the comment-list screen shown in FIG. 5A is displayed on the display 26. Here, when the comment operation section 38 is tapped, the user terminal 1 sends, to the server 100, comment request information for requesting a comment list of the chapter in which the corresponding comment operation section 38 is provided. The server 100 sends, to the user terminal 1, comment-list information including all comments for the chapter corresponding to the received comment request information. The user terminal 1 displays the comment-list screen on the display 26 on the basis of the received comment-list information.

At an upper section of the comment-list screen, a display-order change operation section 45 is provided. The display-order change operation section 45 includes a most-liked-order operation section 45a and a newest-first-order operation section 45b. Then, in the initial state, the new-order operation section 45b is selected.

Furthermore, at a central section of the comment-list screen, a comment display region 46 for displaying a list of comments is provided. In the comment display region 46, comments are displayed in order based on the selection made in the display-order change operation section 45. In FIGS. 5A to 5D, comments are displayed in such an order that new comments are listed above, on the basis of the selection of the new-order operation section 45b.

The comment display region 46 displays, for each comment, the content of the comment (“cool”, “want to see next soon”, or the like), the comment-posted date and time, a like button 47, and “the number of likes”. The like button 47 is an operation section for accepting a tap operation of the user and is tapped by the user when the user likes the content of a comment of another user. When the like button 47 is tapped, “the number of likes” displayed at the right side of the like button 47 is incremented by one and is displayed. Therefore, “the number of likes” serves as a barometer indicating favorable responses from other users, and it is indicated that a comment for which “the number of likes” is large has had favorable responses from many other users.

Furthermore, at a lower section of the comment-list screen, a comment input field 48 for inputting a comment is provided. Although “input a comment”, for example, is written in the comment input field 48, a comment has not actually been input. Then, when the comment input field 48 is tapped, the comment input field 48 is moved to the center of the display 26, as shown in FIG. 5B, and a post operation section 49 and a software keyboard 50 are displayed at a lower section of the display 26. The post operation section 49 includes a normal-post operation section (comment transmission operation section) 49a and a coin-attached-post operation section (value-information-attached-comment transmission operation section) 49b.

When a comment (letters, symbols, etc.,) is input through the software keyboard 50, the comment, e.g., “it was good this time, too!”, input through the software keyboard 50 is displayed in the comment input field 48, as shown in FIG. 5C. After that, when the normal-post operation section 49a is tapped, comment information indicating the input comment is sent from the user terminal 1 to the server 100. In other words, when the normal-post operation section 49a is tapped, the comment displayed in the comment input field 48 is posted.

At the server 100, in the case where the comment included in the received comment information satisfies a predetermined condition, check information indicating that the comment has been accepted normally is sent to the user terminal 1. Here, the predetermined condition is that the comment includes no letters etc. registered in a forbidden-word list stored in the server 100, for example.

At the user terminal 1, on the basis of the received check information, the posted comment is displayed as the latest comment in the comment display region 46, as shown in FIG. 5D. Note that, in the case where the comment is accepted normally, the server 100 may send the comment-list information including the posted comment to the user terminal 1, and the user terminal 1 may display the comment display region 46 such that the posted comment becomes the latest comment, on the basis of the received comment-list information.

However, even if the normal-post operation section 49a is tapped in a state in which no comment is input, the normal-post operation section 49a does not respond (comment information is not sent), whereby no comment is posted.

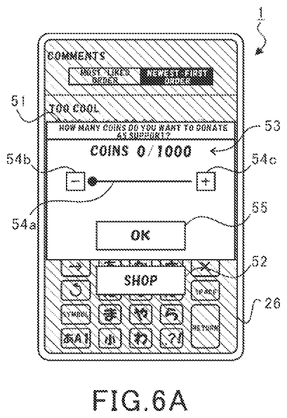

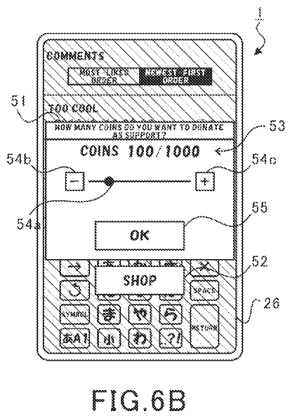

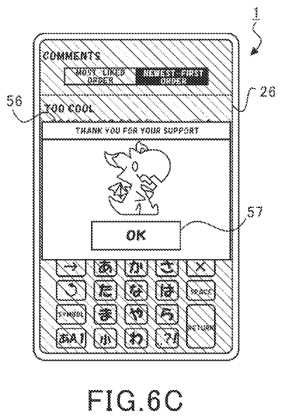

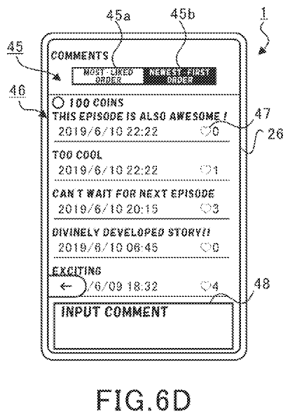

FIG. 6A is a first view for explaining an example of a specified-amount selection pop-up. FIG. 6B is a second view for explaining the example of the specified-amount selection pop-up. FIG. 6C is a view for explaining an example of a coin-attached-post end pop-up. FIG. 6D is a view for explaining an example of the comment-list screen displayed after a coin-attached post is finished.

After a comment is input in the comment input field 48 through the software keyboard 50, when the coin-attached-post operation section 49b is tapped, a specified-amount selection pop-up 51 and a shop operation section 52 are displayed in front of the comment-list screen, as shown in FIG. 6A.

In the specified-amount selection pop-up 51, a specified-amount display region 53, a specified-amount selection operation bar 54a, specified-amount operation sections 54b and 54c, and a confirmation operation section (value-information-attached-comment transmission operation section) 55, in which “OK” is written, are provided. In the specified-amount display region 53, the amount of coins to be donated (given) with the current comment post (hereinafter, referred to as a specified amount, here, “0”) and the amount of coins the user has (the amount of coins associated with the user ID, here, “1000”) are displayed. At the point in time when the specified-amount selection pop-up 51 is displayed, the specified amount is set to 0. Note that, as the amount of coins the user has, the total of free coins and pay coins is displayed, and the free coins and the pay coins are not separately displayed.

The specified-amount selection operation bar 54a indicates the ratio of the specified amount with respect to the amount of coins the user has, and can accept an operation from the user. When the user taps or seeks the specified-amount selection operation bar 54a, as shown in FIG. 6B, the position indicated by the specified-amount selection operation bar 54a is moved, and the specified amount displayed in the specified-amount display region 53 is changed (here, “100”).

The specified-amount operation section 54b is located at the left side of the specified-amount selection operation bar 54a, and “−” is written therein. When the specified-amount operation section 54b is tapped, the specified amount is subtracted at a preset rate, and the specified amount displayed in the specified-amount display region 53 is subtracted. Note that, in the case where the specified amount is “0”, the specified-amount operation section 54b is displayed so as to be darkened out, as shown in FIG. 6A, and does not accept an operation from the user.

The specified-amount operation section 54c is located at the right side of the specified-amount selection operation bar 54a, and “+” is written therein. When the specified-amount operation section 54c is operated, the specified amount is added at a preset rate, and the specified amount displayed in the specified-amount display region 53 is added. Note that, in the case where the specified amount is the same as the amount of coins the user has, the specified-amount operation section 54c is displayed in a darkened out manner and does not accept an operation from the user.

After the user determines (specifies) the specified amount by operating the specified-amount selection operation bar 54a, the specified-amount operation section 54b, or the specified-amount operation section 54c, when the confirmation operation section 55 is tapped, comment information indicating the input comment and specified-amount information indicating the specified amount are sent from the user terminal 1 to the server 100. At the server 100, in the case where the comment included in the received comment information satisfies the predetermined condition, check information indicating that the comment has been accepted normally is sent to the user terminal 1. Furthermore, in the case where the comment has been accepted normally, the server 100 reduces the amount of coins associated with the user ID by the specified amount and sends a support appreciation image to the user terminal 1. At the user terminal 1, a coin-attached-post end pop-up 56 is displayed in front of the comment-list screen, as shown in FIG. 6C, on the basis of the received support appreciation image. Note that the donated coins are donated to the author, for example. Furthermore, at the server 100, the specified amount is subtracted preferentially from the free coins, and is subtracted from the pay coins only in the case where the specified amount exceeds the amount of free coins.

In the coin-attached-post end pop-up 56, the support appreciation image sent from the server 100 is displayed, and a confirmation operation section 57, in which “OK” is written, is displayed. Note that the support appreciation image displayed in the coin-attached-post end pop-up 56 may be an image different for each comic or may be an image common to all comics. Furthermore, the support appreciation image may be made different depending on the amount of donated coins or may be made different depending on the total amount of donated coins.

After that, when the confirmation operation section 57 is tapped, a comment-list image shown in FIG. 6D is displayed on the display 26. At this time, the posted comment is displayed in the comment display region 46 as the latest comment, and the specified amount, that is, the amount of donated coins, is displayed in the comment display region 46 so as to be linked with the comment.

In this way, in this embodiment, coins can be donated to an author (donation target) only with a comment. Therefore, a user who wants to donate coins is required to input any comment in the comment input field 48. Accordingly, the comment display function for inputting or displaying comments can be livened-up.

Note that, while the specified-amount selection pop-up 51 is displayed, when the confirmation operation section 55 is tapped with the specified amount being set to “0”, only the comment information is sent to the server 100, as in the case where the normal-post operation section 49a is tapped. Therefore, in the case where a user who will not donate coins inputs a comment and then accidentally taps the coin-attached-post operation section 49b, the user specifies “0” as the specified amount and taps the confirmation operation section 55, thereby making it possible to post the comment without consuming (donating) coins.

Furthermore, while the specified-amount selection pop-up 51 is displayed, when the shop operation section 52 is operated, a screen for purchasing coins is displayed on the display 26. Then, when the user purchases coins, the comment-list screen with a comment input to the comment input field 48, as shown in FIG. 5C, is displayed on the display 26.

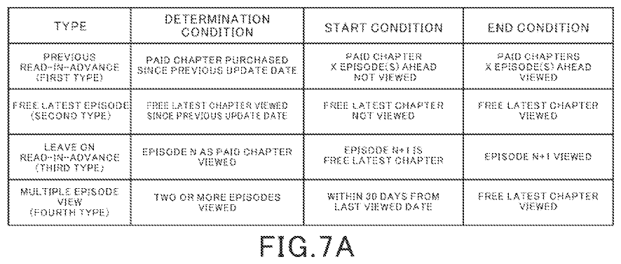

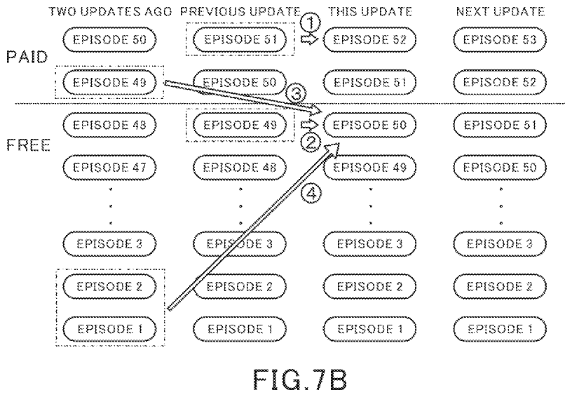

FIG. 7A is a view for explaining viewing-state classifications, determination conditions, start conditions, and end conditions. FIG. 7B is a view for explaining an example case where the comic icon 34 is displayed in the recommended-comic display region 31 in accordance with the viewing state.

As described above, in the recommended-comic display region 31 (see FIG. 3A and FIG. 4D), the comic icons 34 of comics that have been viewed at least once by the user are displayed in the case where predetermined conditions (determination condition, display condition) are satisfied.

Specifically, when the home screen shown in FIG. 3A is displayed on the display 26 and when the end screen shown in FIG. 4D is displayed on the display 26, the user terminal 1 sends recommendation request information for inquiring about a comic icon 34 to be displayed in the recommended-comic display region 31. At the server 100, in the case where the recommendation request information is received, it is determined whether the viewing state of each comic corresponds to any of four classifications shown in FIG. 7A, on the basis of the user's viewing history. Note that, although a description will be given of a case in which four classifications, i.e., a first classification to a fourth classification, are provided in the viewing-state classification, it is possible that any of the four classifications is not provided or that another classification is also included.

The server 100 determines whether there is a comic that corresponds to the first classification “previous read-in-advance”, which has the highest priority among the four classifications. For the first classification “previous read-in-advance”, a determination condition is set such that, with the latest free chapter serving as a reference, a pay chapter that is X-episodes (X is 1 or 2) ahead of the reference has been purchased (viewed) since the last update date. That is, on the determination condition for the first classification “previous read-in-advance”, purchasing (viewing) of a chapter is determined while distinguishing between the latest pay chapter and the pay chapter that is one-episode older than the latest pay chapter. Then, in the case where there is a comic that satisfies the determination condition for the first classification “previous read-in-advance”, the server 100 determines that the viewing-state classification of this comic is the first classification “previous read-in-advance”.

Then, the server 100 determines whether the comic that satisfies the determination condition for the first classification “previous read-in-advance” satisfies a start condition therefor. For the first classification “previous read-in-advance”, a start condition is set such that a pay chapter that is X-episodes ahead at the current update has not been viewed.

Furthermore, the server 100 determines whether the comic that satisfies the determination condition for the first classification “previous read-in-advance” satisfies an end condition therefor. For the first classification “previous read-in-advance”, an end condition is set such that the pay chapter that is X-episodes ahead at the current update has been viewed.

In the case where the comic that satisfies the determination condition for the first classification “previous read-in-advance” satisfies the start condition therefor and does not satisfy the end condition therefor, the server 100 determines that this comic is a comic to be displayed in the recommended-comic display region 31. Note that it can also be said that satisfying the start condition and not satisfying the end condition are set as a display condition for being displayed in the recommended-comic display region 31.

In the example shown in FIG. 7B, it is assumed that a 52nd episode is added at the current update, as indicated by “1” in the figure. In such a case, when a 51st episode (X=2) provided as a pay chapter has been purchased (viewed) since the last update date, and the 52nd episode (X=2) has not been viewed, it is determined that this comic is a comic to be displayed in the recommended-comic display region 31.

Then, the server 100 determines whether there is a comic that corresponds to a second classification “free latest episode”, which has the second highest priority next to the first classification, among comics excluding a comic that corresponds to the first classification “previous read-in-advance”. For the second classification “free latest episode”, a determination condition is set such that the latest free chapter has been viewed since the last update date. Then, in the case where there is a comic that satisfies the determination condition for the second classification “free latest episode”, the server 100 determines that the viewing-state classification of this comic is the second classification “free latest episode”.

Then, the server 100 determines whether the comic that satisfies the determination condition for the second classification “free latest episode” satisfies a start condition therefor. For the second classification “free latest episode”, a start condition is set such that a free chapter added at the current update (the latest free chapter) has not been viewed.

Furthermore, the server 100 determines whether the comic that satisfies the determination condition for the second classification “free latest episode” satisfies an end condition therefor. For the second classification “free latest episode”, an end condition is set such that the free chapter added at the current update date has been viewed.

In the case where the comic that satisfies the determination condition for the second classification “free latest episode” satisfies the start condition therefor and does not satisfy the end condition therefor, the server 100 determines that this comic is a comic to be displayed in the recommended-comic display region 31.

In the example shown in FIG. 7B, it is assumed that a 50th episode is added to the free chapters at the current update, as indicated by “2” in the figure. In such a case, when a 49th episode provided as the latest free chapter has been viewed since the last update date, and the 50th episode has not been viewed, it is determined that this comic is a comic to be displayed in the recommended-comic display region 31.

Then, the server 100 determines whether there is a comic that corresponds to a third classification “leave on read-in-advance”, which has the third highest priority next to the first classification “previous read-in-advance” and the second classification “free latest episode”, among comics excluding comics that correspond to the first classification and the second classification. For the third classification “leave on read-in-advance”, a determination condition is set such that a pay chapter (N-th episode) has been purchased (viewed) at any timing. Then, in the case where there is a comic that satisfies the determination condition for the third classification “leave on read-in-advance”, the server 100 determines that the viewing-state classification of this comic is the third classification “leave on read-in-advance”.

Then, the server 100 determines whether the comic that satisfies the determination condition for the third classification “leave on read-in-advance” satisfies a start condition therefor. For the third classification “leave on read-in-advance”, a start condition is set such that the next chapter after the purchased (viewed) pay chapter is the latest free chapter (N+1-th episode) that has not been viewed.

Furthermore, the server 100 determines whether the comic that satisfies the determination condition for the third classification “leave on read-in-advance” satisfies an end condition therefor. For the third classification “leave on read-in-advance”, an end condition is set such that the next free chapter (N+1-th episode) after the purchased (viewed) pay chapter has been viewed.

In the case where the comic that satisfies the determination condition for the third classification “leave on read-in-advance” satisfies the start condition therefor and does not satisfy the end condition therefor, the server 100 determines that this comic is a comic to be displayed in the recommended-comic display region 31.

In the example shown in FIG. 7B, as indicated by “3” in the figure, in the case where the 49th episode provided as a pay chapter has been viewed since the update date at the time before the last time, the 50th episode is added to the free chapters at the current update, and the 50th episode has not been viewed, it is determined that this comic is a comic to be displayed in the recommended-comic display region 31.

Then, the server 100 determines whether there is a comic that corresponds to a fourth classification “multiple episode view”, which has the lowest priority, among comics excluding comics that correspond to the first classification “previous read-in-advance”, the second classification “free latest episode”, and the third classification “leave on read-in-advance”. For the fourth classification “multiple episode view”, a determination condition is set such that chapters of two or more episodes have been viewed. Then, in the case where there is a comic that satisfies the determination condition for the fourth classification “multiple episode view”, the server 100 determines that the viewing-state classification of this comic is the fourth classification “multiple episode view”. Note that, although the determination condition in which chapters of two or more episodes have been viewed is set here, the number of viewed chapters can be any number as long as it is more than one.

Then, the server 100 determines whether the comic that satisfies the determination condition for the fourth classification “multiple episode view” satisfies a start condition therefor. For the fourth classification “multiple episode view”, a start condition is set such that it is within 30 days from the latest viewing date of the comic.

Furthermore, the server 100 determines whether the comic that satisfies the determination condition for the fourth classification “multiple episode view” satisfies an end condition therefor. For the fourth classification “multiple episode view”, an end condition is set such that the latest free chapter has been viewed.

In the case where the comic that satisfies the determination condition for the fourth classification “multiple episode view” satisfies the display condition therefor and does not satisfy the end condition therefor, the server 100 determines that this comic is a comic to be displayed in the recommended-comic display region 31.

In the example shown in FIG. 7B, as indicated by “4” in the figure, in the case where a 1st episode and a 2nd episode have been viewed since the update date at the time before the last time, and a new chapter of this comic has not been viewed, it is determined that this comic is a comic to be displayed in the recommended-comic display region 31.

In this way, in the case where a comic corresponds to any of the first classification to the fourth classification (satisfies the determination condition therefor) and further satisfies the display condition therefor, the server 100 determines that this comic is a comic to be displayed in the recommended-comic display region 31. Then, after identifying a comic to be displayed in the recommended-comic display region 31, the server 100 sends the comic icon 34 of this comic to the user terminal 1 as recommendation information to be displayed in the recommended-comic display region 31.

As a result, at the user terminal 1, when the home screen shown in FIG. 3A or the end screen shown in FIG. 4D is displayed on the display 26, the comic icon 34 corresponding to the comic identified at the server 100 can be displayed in the recommended-comic display region 31.

Accordingly, at the user terminal 1, the comic icon 34 of the comic that has been viewed at least once by the user and that would be viewed by the user can be preferentially displayed in the recommended-comic display region 31 in accordance with the viewing-state classification thereof. Therefore, the user can easily view the target comic just by tapping the comic icon 34 displayed in the recommended-comic display region 31.

Next, communication processing between the user terminal 1 and the server 100 will be described. Note that, examples of the basic communication processing for viewing a comic, communication processing for determining a comic icon 34 to be displayed in the recommended-comic display region 31, and communication processing for posting a comment will be described below, and a description of other processing will be omitted.

(Communication Processing Between User Terminal 1 and Server 100)

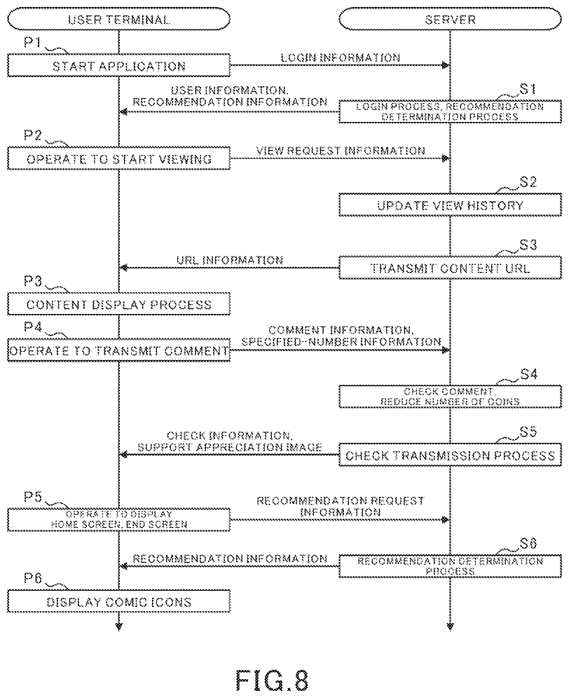

FIG. 8 is a sequence diagram for explaining the basic processing at the user terminal 1 and the server 100. Note that, in the following description, processing at the user terminal 1 is indicated by Pn (n is an arbitrary integer). Furthermore, processing at the server 100 is indicated by Sn (n is an arbitrary integer). At the user terminal 1, when the user activates the application (P1), login information (including recommendation request information) is sent from the user terminal 1 to the server 100. Upon reception of the login information, the server 100 executes login processing by identifying the user ID associated with the login information and recommendation determining processing for identifying a comic to be displayed in the recommended-comic display region 31 (S1). Here, the server 100 sends user information corresponding to the identified user ID, and recommendation information to the user terminal 1.

Furthermore, when any chapter is tapped in the chapter selection screen shown in FIG. 3D, the user terminal 1 sends viewing request information for viewing this chapter (P2). When the viewing request information is received, the server 100 updates the viewing history (S2) and sends URL information indicating a URL where images of the chapter exist (S3). At the user terminal 1, when the URL information is received, the URL included in the URL information is accessed, thus executing content displaying processing for displaying the page images 42 of this chapter on the display 26 (P3).

Furthermore, at the user terminal 1, when the comment-list screen shown in FIG. 5C is displayed on the display 26, and the post operation section 49 is operated with a comment input to the comment input field 48, only comment information indicating the comment or the comment information and specified-amount information added thereto are sent to the server 100 (P4). At the server 100, when the comment information or the comment information and the specified-amount information are received, the comment included in the comment information is checked (S4). Furthermore, in the case where the specified-amount information is received, the server 100 performs subtraction from the amount of coins associated with the user ID (S4). Furthermore, the server 100 sends check information and sends a support appreciation image (S5).

Furthermore, at the user terminal 1, in the case where an operation for displaying the home screen shown in FIG. 3A or the end screen shown in FIG. 4D is performed, the user terminal 1 sends recommendation request information to the server 100 (P5). When the recommendation request information is received, the server 100 executes recommendation determining processing (S6) and sends recommendation information to the user terminal 1. When the recommendation information is received, the user terminal 1 displays the comic icon 34 of a comic included in the recommendation information, in the recommended-comic display region 31 in the home screen or the end screen (P6).

(Functional Configuration of User Terminal 1)

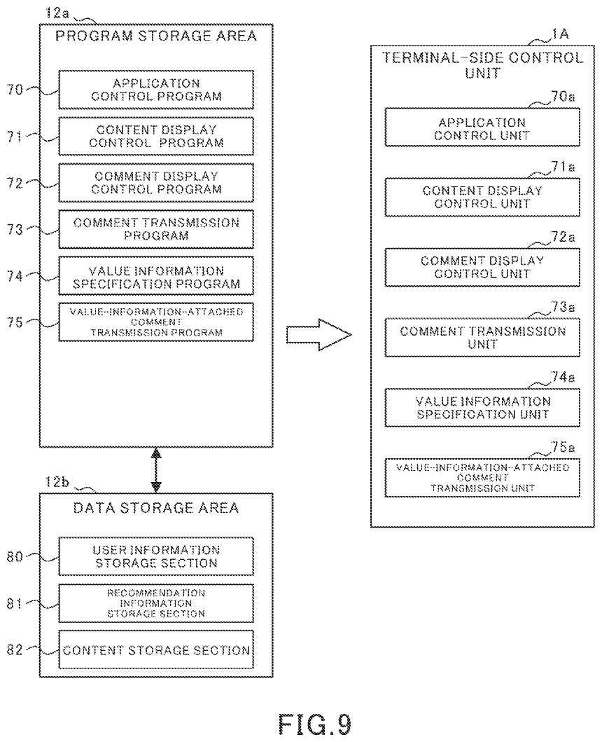

FIG. 9 is a view for explaining the configuration of the memory 12 and the function as a computer at the user terminal 1. In the memory 12, a program storage area 12a and a data storage area 12b are provided. When the application is executed, the CPU 10 stores terminal-side control programs (modules) in the program storage area 12a.

The terminal-side control programs include an application control program 70, a content-display control program 71, a comment-display control program 72, a comment transmitting program 73, a value-information specifying program 74, and a value-information-attached-comment transmitting program 75. Note that the programs listed in FIG. 9 are merely examples, and a large number of other programs are also provided as the terminal-side control programs.

In the data storage area 12b, a user-information storage section 80, a recommendation-information storage section 81, and a content storage section 82 are provided as storage sections for storing data. Note that the above storage sections are merely examples, and a large number of other storage sections are also provided in the data storage area 12b.

The CPU 10 runs the individual programs stored in the program storage area 12a and updates data in the individual storage sections of the data storage area 12b. Then, the CPU 10 runs the individual programs stored in the program storage area 12a, thereby causing the user terminal 1 (computer) to function as a terminal-side control unit 1A. The terminal-side control unit 1A includes an application control unit 70a, a content-display control unit 71a, a comment-display control unit 72a, a comment transmitting unit 73a, a value-information specifying unit 74a, and a value-information-attached-comment transmitting unit 75a.

Specifically, the CPU 10 runs the application control program 70, thereby causing the computer to function as the application control unit 70a. Similarly, the CPU 10 runs the content-display control program 71, the comment-display control program 72, the comment transmitting program 73, the value-information specifying program 74, and the value-information-attached-comment transmitting program 75, thereby causing the computer to function as the content-display control unit 71a, the comment-display control unit 72a, the comment transmitting unit 73a, the value-information specifying unit 74a, and the value-information-attached-comment transmitting unit 75a, respectively.

The application control unit 70a executes application control processing for controlling display in the whole application for viewing content. The application control program 70 displays, for example, the home screen on the display 26 in response to an operation with respect to the user terminal 1. Furthermore, the application control unit 70a updates information in the user-information storage section 80 in the case where user information is updated.

When receiving URL information from the server 100, the content-display control unit 71a accesses the URL included in the received URL information. Then, the content-display control unit 71a downloads the page images 42 from the accessed URL and stores the downloaded page images 42 in the content storage section 82. Furthermore, the content-display control unit 71a displays the page images 42 stored in the content storage section 82, on the display 26 so as to be able to be viewed.

When the comment operation section 38 is tapped, the comment-display control unit 72a displays the comment-list image on the display 26. Furthermore, when a comment is input through the software keyboard 50, the comment-display control unit 72a displays the input comment in the comment input field 48.

When the normal-post operation section 49a is tapped, the comment transmitting unit 73a sends, to the server 100, comment information including the comment input to the comment input field 48.

When the coin-attached-post operation section 49b is tapped, the value-information specifying unit 74a displays the specified-amount selection pop-up 51 in front of the comment-list screen. Furthermore, the value-information specifying unit 74a specifies the specified amount in response to an operation using the specified-amount selection operation bar 54a, the specified-amount operation section 54b, or the specified-amount operation section 54c displayed in the specified-amount selection pop-up 51.

When the confirmation operation section 55 displayed in the specified-amount selection pop-up 51 is tapped, the value-information-attached-comment transmitting unit 75a sends, to the server 100, comment information including the comment input to the comment input field 48 and specified-amount information including the specified amount.

(Specific Processing at User Terminal 1)

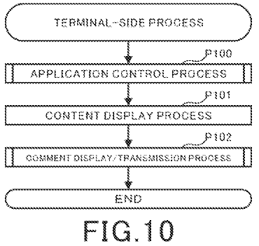

FIG. 10 is a flowchart for explaining an example of terminal-side processing at the user terminal 1. In the terminal-side processing, the application control unit 70a executes application control processing including recommendation displaying processing for displaying the comic icon 34 in the recommended-comic display region 31 (P100). Furthermore, the content-display control unit 71a executes content displaying processing for displaying a comic screen on the display 26 (P101). The comment-display control unit 72a, the comment transmitting unit 73a, the value-information specifying unit 74a, and the value-information-attached-comment transmitting unit 75a execute comment displaying/transmitting processing for displaying comments and for sending a comment (P102).

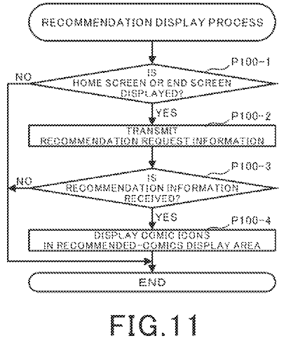

FIG. 11 is a flowchart for explaining an example of the recommendation displaying processing at the user terminal 1. In the case where the home screen or the end screen is displayed on the display 26 (YES in P100-1), the application control unit 70a sends recommendation request information to the server 100 (P100-2). Then, in the case where recommendation information is received from the server 100 (YES in P100-3), the application control unit 70a stores the recommendation information in the recommendation-information storage section 81 and displays the comic icon 34 in the recommended-comic display region 31 (P100-4).

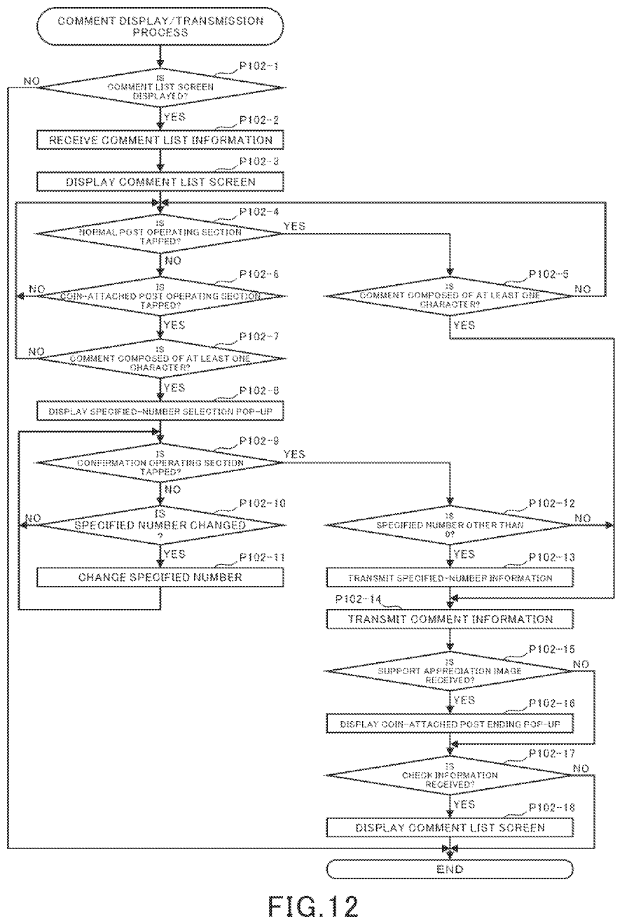

FIG. 12 is a flowchart for explaining an example of the comment displaying/transmitting processing at the user terminal 1. In the case where the comment-list screen is displayed on the display 26 (YES in P102-1), the comment-display control unit 72a sends comment request information for requesting a comment list for each chapter, for which the comment operation section 38 is provided. Then, when comment-list information is received from the server 100 (P102-2), the comment-display control unit 72a displays the comment-list screen on the display 26 on the basis of the comment-list information (P102-3).

Furthermore, when the comment input field 48 is tapped, and then the normal-post operation section 49a is tapped (YES in P102-4), if a comment having one or more letters is input to the comment input field 48 (YES in P102-5), the comment transmitting unit 73a sends comment information including the comment (P102-14).

On the other hand, in the case where the coin-attached-post operation section 49b is tapped (YES in P102-6), if a comment having one or more letters is input to the comment input field 48 (YES in P102-7), the value-information specifying unit 74a displays the specified-amount selection pop-up 51 on the display 26 (P102-8).

Then, until the confirmation operation section 55 in the specified-amount selection pop-up 51 is tapped (NO in P102-9), if the specified amount is changed by operating the specified-amount selection operation bar 54a, the specified-amount operation section 54b, or the specified-amount operation section 54c (YES in P102-10), the value-information specifying unit 74a specifies (changes) the specified amount in response to the operation (P102-11).

After that, when the confirmation operation section 55 in the specified-amount selection pop-up 51 is tapped (YES in P102-9), if the specified amount is other than 0 (YES in P102-12), the value-information-attached-comment transmitting unit 75a sends specified-amount information indicating the specified amount to the server 100 (P102-13). Furthermore, the comment transmitting unit 73a sends comment information (P102-14).

Furthermore, in the case where a support appreciation image is received from the server 100 (YES in P102-15), the comment-display control unit 72a displays the coin-attached-post end pop-up 56 on the display 26 (P102-16). Furthermore, in the case where check information is received from the server 100 (YES in P102-17), the comment-display control unit 72a displays the comment-list screen on the display 26 (P102-18).

(Functional Configuration of Server 100)

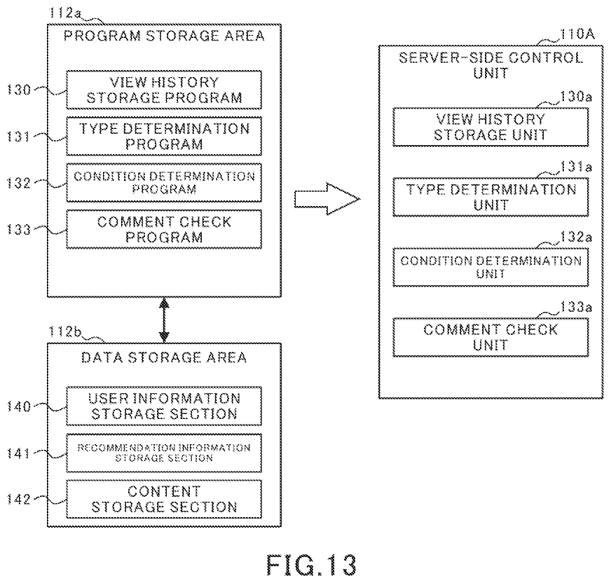

FIG. 13 is a view for explaining the configuration of the memory 112 and the function as a computer at the server 100. In the memory 112, a program storage area 112a and a data storage area 112b are provided. The CPU 110 stores server-side control programs (modules) in the program storage area 112a.

The server-side control programs include a viewing-history storing program 130, a classification determining program 131, a condition determining program 132, and a comment checking program 133. Note that the programs listed in FIG. 13 are merely examples, and a large number of other programs are also provided as the server-side control programs.

In the data storage area 112b, a user-information storage section 140, a recommendation-information storage section 141, and a content storage section 142 are provided as storage sections for storing data. Note that the above individual storage sections are merely examples, and a large number of other storage sections are also provided in the data storage area 112b.

The CPU 110 runs the individual programs stored in the program storage area 112a and updates data in the individual storage sections of the data storage area 112b. Then, the CPU 110 runs the individual programs stored in the program storage area 112a, thereby causing the server 100 (computer) to function as a server-side control unit 110A. The server-side control unit 110A includes a viewing-history storing unit 130a, a classification determining unit 131a, a condition determining unit 132a, and a comment checking unit 133a.

Specifically, the CPU 10 runs the viewing-history storing program 130, thereby causing the computer to function as the viewing-history storing unit 130a. Similarly, the CPU 10 runs the classification determining program 131, the condition determining program 132, and the comment checking program 133, thereby causing the computer to function as the classification determining unit 131a, the condition determining unit 132a, and the comment checking unit 133a, respectively.

Every time viewing request information is sent from the user terminal 1, the viewing-history storing unit 130a updates the viewing history for each user ID on the basis of the viewing request information and stores the updated viewing history in the user-information storage section 140. Furthermore, the viewing-history storing unit 130a sends, to the user terminal 1, URL information indicating the URL of the page images 42 stored in the content storage section 142, on the basis of the viewing request information.

When recommendation request information is received from the user terminal 1, the classification determining unit 131a determines the viewing-state classification of each comic on the basis of the viewing history stored in the user-information storage section 140.

The condition determining unit 132a determines whether the comic, of which the viewing-state classification has been determined by the classification determining unit 131a, satisfies the display condition based on the viewing-state classification thereof. Furthermore, the condition determining unit 132a reads the comic icon 34 of the comic that satisfies the display condition from the recommendation-information storage section 141 and sends the comic icon 34 to the user terminal 1 as recommendation information.

When comment information is received from the user terminal 1, the comment checking unit 133a determines whether the comment included in the comment information satisfies a predetermined condition. When specified-amount information is received from the user terminal 1, the comment checking unit 133a subtracts a specified amount from the amount of coins associated with the user ID.

(Specific Processing at Server 100)

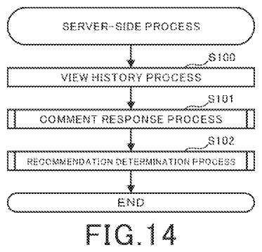

FIG. 14 is a flowchart for explaining an example of server-side processing at the server 100. In the server-side processing, the viewing-history storing unit 130a sends URL information on the basis of viewing request information received from the user terminal 1 and executes viewing history processing for updating the viewing history (S100). Furthermore, the comment checking unit 133a executes comment handling processing based on comment information or specified-amount information received from the user terminal 1 (S101). Furthermore, the classification determining unit 131a and the condition determining unit 132a execute recommendation determining processing when recommendation request information is received from the user terminal 1 (S102).

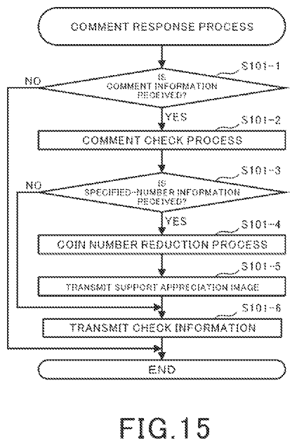

FIG. 15 is a flowchart for explaining an example of the comment handling processing at the server 100. When comment information is received (YES in S101-1), the comment checking unit 133a executes comment checking processing for checking the comment included in the comment information (S101-2). Furthermore, in the case where specified-amount information has been attached to the comment information, that is, in the case where specified-amount information is received together with the comment information (YES in S101-3), the comment checking unit 133a executes amount-of-coin subtracting processing for subtracting the specified amount included in the specified-amount information from the amount of coins associated with the user ID (S101-4). After that, the comment checking unit 133a sends a support appreciation image to the user terminal 1 (S101-5). Furthermore, the comment checking unit 133a sends check information to the user terminal 1 (S101-6).

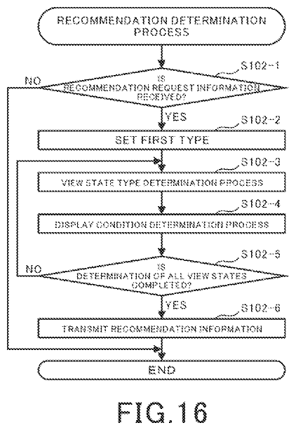

FIG. 16 is a flowchart for explaining an example of the recommendation determining processing at the server 100. When recommendation request information is received (YES in S102-1), the classification determining unit 131a sets the first classification (S102-2) and executes viewing-state-classification determining processing for determining whether there is a comic that satisfies the determination condition for the first classification on the basis of the viewing history (S102-3). Then, the condition determining unit 132a executes display-condition determining processing for determining whether the comic that satisfies the determination condition for the first classification satisfies the display condition (S102-4). After that, if these determinations are not finished for all viewing-state classifications (NO in S102-5), the classification determining unit 131a and the condition determining unit 132a execute the processing of S102-3 and S102-4 for the viewing-state classification that has the next lower priority.

Then, if these determinations are finished for all viewing-state classifications (YES in S102-5), the condition determining unit 132a sends recommendation information including the comic icon 34 of the comic that satisfies the display condition, to the user terminal 1 (S102-6).

As described above, the user terminal 1 has the application control program 70, the content-display control program 71, the comment-display control program 72, the comment transmitting program 73, the value-information specifying program 74, and the value-information-attached-comment transmitting program 75 provided therein. Furthermore, the user terminal 1 includes the application control unit 70a, the content-display control unit 71a, the comment-display control unit 72a, the comment transmitting unit 73a, the value-information specifying unit 74a, and the value-information-attached-comment transmitting unit 75a. However, these programs and functional units may be provided in the server 100.

Furthermore, the server 100 has the viewing-history storing program 130, the classification determining program 131, the condition determining program 132, and the comment checking program 133 provided therein. Furthermore, the server 100 includes the viewing-history storing unit 130a, the classification determining unit 131a, the condition determining unit 132a, and the comment checking unit 133a. However, these programs and functional units may be provided in the user terminal 1.

Furthermore, an content item may be composed of a plurality of images (pay partial content items) respectively created by a plurality of authors, and a competition for the amounts of coins donated to the respective images may be held. In this case, it is possible to provide a new image (partial content) to a user who purchases an image to which the highest amount of coins is donated. Accordingly, it is possible to increase the willingness to support the authors.

Furthermore, the end condition used in the recommendation determining processing may include a condition that a certain period of time, e.g., 30 days, has passed.

Furthermore, at the user terminal 1, when comments are displayed in the comment-list screen, the display mode (appearance), such as color and size, of each of the comments may be changed in accordance with the amount of coins donated therewith.

Furthermore, at the user terminal 1, it is also possible to provide, as a screen that can be transited from the home screen or the like, a screen on which the coin usage history can be viewed. On the screen on which the coin usage history can be viewed, a purchased pay chapter (pay partial content), a comic (content) to which coins (value information) are donated, and the amount of donated coins may be displayed.

Furthermore, in the recommendation determining processing, although it is determined whether the determination condition and the display condition are satisfied for all classifications from the first classification to the fourth classification, for example, in the case where there is a comic (content) that satisfies the determination condition and the display condition for the first classification, the recommendation determining processing may be finished at this point.

Furthermore, the value information may be cash information.

Furthermore, comments to be displayed on the comment-list screen can also be sorted by the amount of coins, in addition to by the number of likes and in descending order of date and time. In this case, comments may be displayed in descending order of the amount of donated coins or in ascending order of the amount of donated coins.

Although an aspect of the embodiment has been described above with reference to the accompanying drawings, it goes without saying that the present invention is not limited to the embodiment described above. It would be obvious that a person skilled in the art could conceive of various modifications and amendments within the scope recited in the claims, and it will be understood that those modifications and amendments obviously belong to the technical scope of the present invention.

What is claimed is:

1. A non-transitory computer readable medium storing a program causing a computer to execute:
sending a comment input by a user when transmission of the comment is ordered and the comment satisfies a predetermined transmission condition;
displaying the sent comment in a list;
specifying an amount of value to be donated to a donation target; and
sending the comment and the specified amount of valuewhen transmission of the comment and the specified amount of value is ordered and the comment satisfies the transmission condition,
wherein displaying the sent comment in the list includes displaying the comment and the specified amount of value with being associated with each other when the comment and the specified amount of value are sent, and
wherein the value can be donated only when the comment is sent.

2. The medium according to claim 1, wherein sending the comment and the specified amount of value can be executed when at least one letter is input to a comment input region.

3. The medium according to claim 1, wherein only the comment is sent when the specified amount of value is 0.

4. The medium according to claim 2, wherein only the comment is sent when the specified amount of value is 0.

5. The medium according to claim 1,
wherein the value includes free value that can be obtained for free and pay value that can be obtained for a fee, and the free value and the pay value are managed separately, and
wherein the free value is consumed first when the comment and the specified amount of value are sent.

6. The medium according to claim 2,
wherein the value includes free value that can be obtained for free and pay value that can be obtained for a fee, and the free value and the pay value are managed separately, and
wherein the free value is consumed first when the comment and the specified amount of value are sent.

7. The medium according to claim 3,
wherein the value includes free value that can be obtained for free and pay value that can be obtained for a fee, and the free value and the pay value are managed separately, and
wherein the free value is consumed first when the comment and the specified amount of value are sent.

8. The medium according to claim 4,
wherein the value includes free value that can be obtained for free and pay value that can be obtained for a fee, and the free value and the pay value are managed separately, and
wherein the free value is consumed first when the comment and the specified amount of value are sent.

9. An information processing method comprising:
sending a comment input by a user when transmission of the comment is ordered and the comment satisfies a predetermined transmission condition;
displaying the sent comment in a list;
specifying an amount of value to be donated to a donation target;
sending the comment and the specified amount of value when transmission of the comment and the specified amount of value is ordered and the comment satisfies the transmission condition; and
displaying the comment and the specified amount of value with being associated with each other when the comment and the specified amount of value are sent,
wherein the value n can be donated only when the comment is sent.

10. An information processing system comprising a computer configured to execute:
sending a comment input by a user when transmission of the comment is ordered and the comment satisfies a predetermined transmission condition;
displaying the sent comment in a list;
specifying an amount of value to be donated to a donation target; and
sending the comment and the specified amount of value when transmission of the comment and the specified amount of value is ordered and the comment satisfies the transmission condition,
wherein displaying the sent comment in the list includes displaying the comment and the specified amount of value with being associated with each other when the comment and the specified amount of value are sent, and
wherein the value can be donated only when the comment is sent.
